(19) United States
(12) Patent Application Publication
(10) Pub. No.: US 2017/0149716 A1
(43) Pub. Date: May 25, 2017

(54) PRIORITIZING DELIVERY OF MESSAGES IN COMMUNICATION SYSTEMS

(71) Applicant: INTERNATIONAL BUSINESS MACHINES CORPORATION, Armonk, NY (US)

(72) Inventors: Peter J. Mostachetti, Kingston, NY (US); Christopher D. Wyble, Poughkeepsie, NY (US); Michael J. Young, Poughkeepsie, NY (US)

(21) Appl. No.: 14/948,512

(22) Filed: Nov. 23, 2015

(51) Int. Cl. H04L 12/58; H04L 29/08

(52) U.S. Cl. CPC H04L 51/26; H04L 67/306

(57) ABSTRACT

Embodiments include method, systems and computer program products for prioritizing delivery of messages across multiple communication systems. Aspects include receiving a message for a recipient via one or more messaging systems and determining a priority level for the message based on an analysis of the message and a user profile of the recipient. Aspects also include delivering the message to a desired communication device via a desired communication system, wherein the desired communication device and the desired communication system are selected based on the priority level and the user profile and receiving feedback from the recipient regarding the priority level and responsively updating the user profile based on the feedback.

### BACKGROUND

The present disclosure relates to delivery of messages via communication systems and more specifically, to methods, systems and computer program products for prioritizing delivery of messages across multiple communication systems.

In today's society, individuals often utilize a variety of different ways to communicate with one another, such as telephone calls or messages via landline phones, cellular phones, or voice over Internet protocol (VoIP) phones, text messages, email, instant messages, social network postings and messages. In addition, individuals may have a number of cell phones, email accounts, and often many social network pages. This proliferation of communication options makes it easy for an individual to not receive important messages in a timely manner or to miss important messages.

Everyone has their own preference as to which form of communication they like to read or use, and which they prioritize over the other forms of communication. Many communications systems allow senders to indicate a priority level of a message or may use algorithms to analyze the message to determine a priority level of the message. The determined priority level may be used to control how the message is transmitted to the recipient. For example, urgent messages may trigger a phone call to the recipient's mobile phone while non-urgent messages may be delivered via email.

However, in some cases the intended recipient of the message may not agree with the priority level assigned by the sender or by the algorithm. This can lead to the recipient receiving what they perceive to be false notifications of urgent messages, which can cause frustration by the recipient.

### SUMMARY

In accordance with an embodiment, a method for prioritizing delivery of messages across multiple communication systems is provided. The method includes receiving a message for a recipient via one or more messaging systems and determining a priority level for the message based on an analysis of the message and a user profile of the recipient. The method also includes delivering the message to a desired communication device via a desired communication system, wherein the desired communication device and the desired communication system are selected based on the priority level and the user profile and receiving feedback from the recipient regarding the priority level and responsively updating the user profile based on the feedback.

In accordance with another embodiment, messaging system for prioritizing delivery of messages across multiple communication systems having a processor in communication with one or more types of memory. The processor is configured to receive a message for a recipient via one or more messaging systems and determine a priority level for the message based on an analysis of the message and a user profile of the recipient. The processor is also configured to deliver the message to a desired communication device via a desired communication system, wherein the desired communication device and the desired communication system are selected based on the priority level and the user profile and receive feedback from the recipient regarding the priority level and responsively updating the user profile based on the feedback.

In accordance with a further embodiment, a computer program product for prioritizing delivery of messages across multiple communication systems includes a non-transitory storage medium readable by a processing circuit and storing instructions for execution by the processing circuit for performing a method. The method includes receiving a message for a recipient via one or more messaging systems and determining a priority level for the message based on an analysis of the message and a user profile of the recipient. The method also includes delivering the message to a desired communication device via a desired communication system, wherein the desired communication device and the desired communication system are selected based on the priority level and the user profile and receiving feedback from the recipient regarding the priority level and responsively updating the user profile based on the feedback.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 is a block diagram illustrating one example of a processing system for practice of the teachings herein;

FIG. 4 is a block diagram illustrating a messaging system in accordance with an exemplary embodiment;

FIG. 5 is a flow diagram of a method for prioritizing delivery of messages across multiple communication systems in accordance with an exemplary embodiment; and

FIG. 6 is a flow diagram of another method for prioritizing delivery of messages across multiple communication systems in accordance with an exemplary embodiment.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

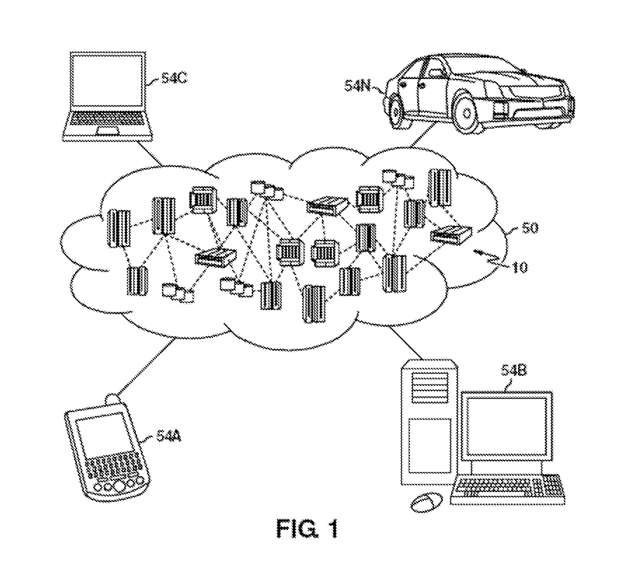

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

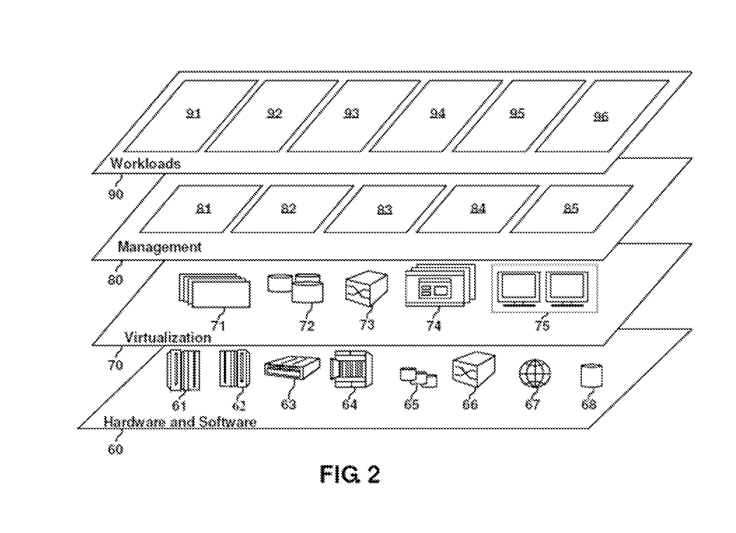

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing of messages across multiple communication systems 96.

In accordance with exemplary embodiments of the disclosure, methods, systems and computer program products for prioritizing delivery of messages across multiple communication systems are provided. In exemplary embodiments, a messaging system is configured to receive messages for an individual across multiple communication systems utilized by the individual. The messaging system is also configured to determine a priority level associated with each of the messages based on an analysis of the messages and a user profile of the individual. Based on the determined priority level and the user profile, the messaging system delivers the messages to a desired communication device via a desired messaging system. In exemplary embodiments, the user profile is updated by the messaging system upon receiving feedback from the individual, wherein the feedback includes message delivery preferences and message priority preferences of the individual.

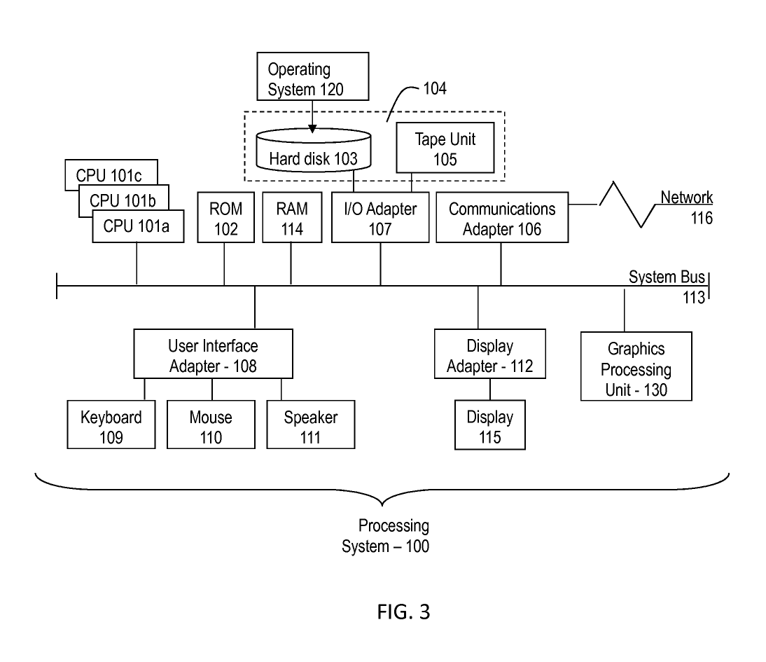

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

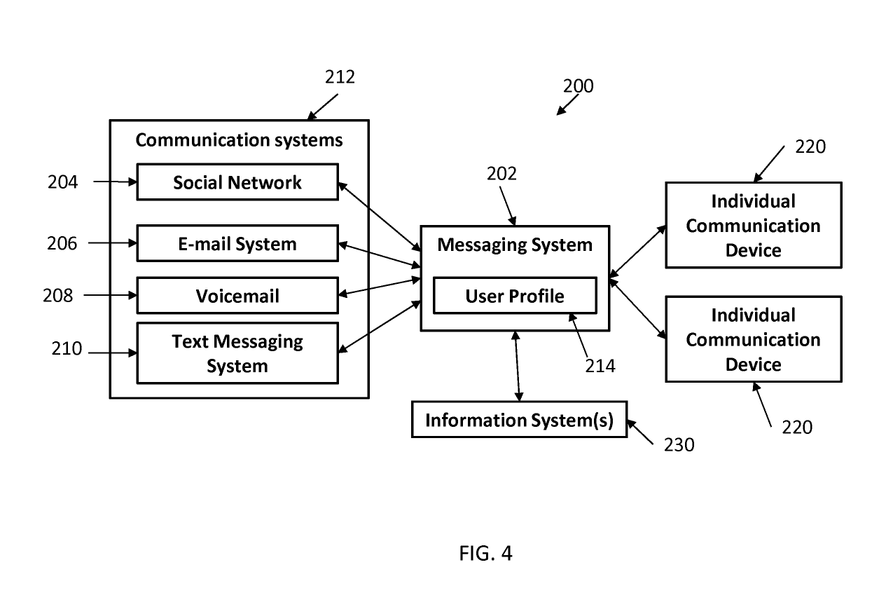

Referring now to FIG. 4, a system 200 for prioritizing delivery of messages is illustrated. As illustrated, the system 200 includes a messaging system 202 that is in communication with one or more individual communication devices 220. The individual communication devices 220 may include cell phones, computers, tablets, landline phones, smart watches and any other suitable device that an individual may use to send or receive messages. In addition, the messaging system 202 is in communication with multiple communication systems 212 and one or more informational systems 230. These communication systems 212 may include, but are not limited to, social networks 204, email systems 206, voicemail systems 208, text messaging systems 210, and other communication systems. The information systems 230 can include public or private databases, such as electronic medical records, social network databases, customer relationship management (CRM) databases, and the like.

In exemplary embodiments, the messaging system 202 can be centralized, as illustrated in FIG. 4, it can be distributed among various communication systems 212 and devices 220, or it may contain both a central portion and a distributed portion. In exemplary embodiments, the messaging system 202 is configured to receive messages for an individual across a plurality of communication systems 212 utilized by the individual. The messaging system 202 determines a priority level for each message received based on an analysis of the message and based on a user profile 214 of the individual. In exemplary embodiments, the delivery of the messages via one or more communication devices 220 is based on the priority level of the message and the user profile 214.

In exemplary embodiments, the priority level of a message can be based on a variety of factors that include, but are not limited to, the sender of the message, the recipients of the message (as known as a distribution list), a content of the message, a sender's indicated priority level, and the like. The messaging system 202 is configured to analyze the content message to determine the priory level of the message. In exemplary embodiments, analysis of the content of the message may include an identification of key words or phrases in the message. The analysis of the message can also include performing a textual analysis that evaluates the tone of the message. Existing systems for analyzing the tone of a message are known and any suitable system or method can be used. In exemplary embodiments, based on the tone of the message, i.e., urgent, excited, agitated, etc. the messaging system 202 may modify the priory level of the message.

In exemplary embodiments, the messaging system 202 further determines the priority level of a message based on the user profile 214. The user profile 214 can be created, modified and/or updated by the messaging system 202 based on feedback received from the individual via one or more of the communications devices 220. The user profile 214 is used to store information for determining the priority level of a message that is specific to an individual recipient. The user profile 214 can include both message delivery preferences and message priority preferences of the individual. In exemplary embodiments, message delivery preferences include the individual's preferences as to how to deliver messages having different priority levels to the individual and message priority preferences include the individual's preferences as to how to determine what priority level to assign to a message.

In exemplary embodiment, the messages delivered to the individuals may include an indication of the determined priority level of the message and indication of why the message was assigned that priority level. For example, the message may be indicated to be urgent, critical, spam, normal, or the like. In addition, the message may include an indication of why the message was give the indicated priority level. In exemplary embodiments, the recipient of the message may select either the indication of the determined priority level or the indication of why the message was give the indicated priority level and elect to provide feedback to the messaging system 202 regarding the determined priority level and/or why the message was give the indicated priority level. The message system 202 is configured to receive feedback from an individual regarding a message that was delivered. The feedback can include instructions on a change in the priority level that should be assigned to new messages that are similar to the delivered message.

In one example, a message may be identified and delivered as an urgent message based on the analysis of the message. When the recipient receives the message, the recipient can provide feedback to the messaging system 202 that the message should not have been determined to be urgent. The feedback can include a reason that the recipient does not want the message to be treated as urgent, such as the sender's messages are never to be treated as urgent, this type of message should not be treated as urgent, or the like. The messaging system 202 can use the feedback provided by the recipient to update the user profile 214 for the recipient. Accordingly, when new messages are received by the messaging system 202 the updated user profile can be used to determine a priority level for the message.

In exemplary embodiments, the messaging system 202 receives messages from each of the communication systems 212, assigns a priority level to each of the messages received and delivers the messages to one or more desired communication device 220 via a desired communication system 212 that is selected based on the assigned priority level and the user profile 214. For example, if a message is received and it is determined to have a highest level of urgency, the messaging system 202 may be configured to transmit the message to all available communication devices 220 simultaneously. In another example, if a message is received and it is determined to have a lowest level of urgency, the messaging system 202 may be configured to transmit the message to only one of the available communication devices 220 indicated by the user profile 214.

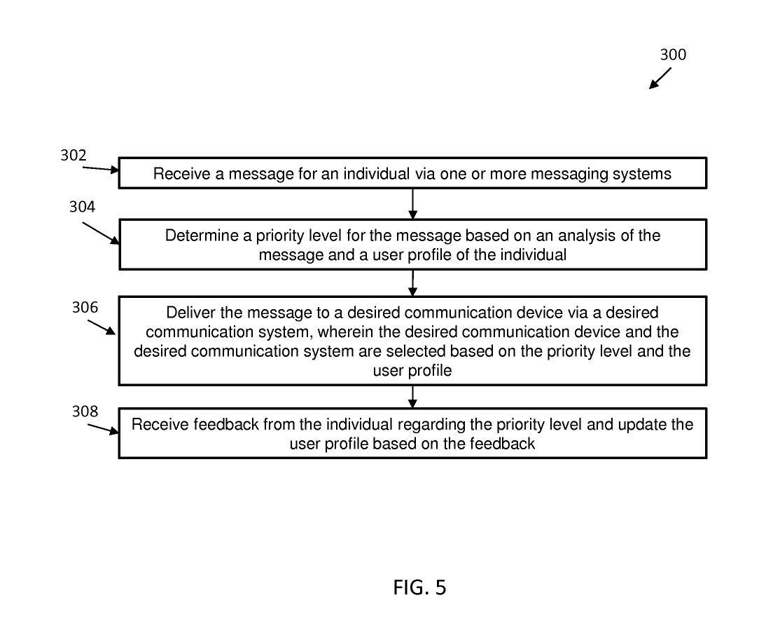

Referring now to FIG. 5, a flow diagram of a method 300 for prioritizing delivery of messages across multiple communication systems in accordance with an exemplary embodiment is shown. As shown at block 302, the method 300 includes receiving a message for an individual via one or more messaging systems. Next, as shown at block 304, the method 300 includes determining a priority level for the message based on an analysis of the message and a user profile of the individual. In exemplary embodiments, the analysis of the message may include analyzing one or more of the content of the message, the sender of the message, a distribution list of the message, or the like. The method 300 also includes delivering the message to a desired communication device via a desired communication system, wherein the desired communication device and the desired communication system are selected based on the priority level and the user profile, as shown at block 306. For example, an urgent message may be delivered via a phone call to an individual while a lower importance message may be delivered via an email or text message. Next, as shown at block 308, the method 300 includes receiving feedback from the individual regarding the priority level and responsively updating the user profile based on the feedback.

In exemplary embodiments, determining a priority level for the message can be further based on analyzing the message in combination with information obtained from an information system. In one embodiment, the informational system may include an electronic medical record database and the analysis of the message may include determining the priority level of the message based on a combination of information in the message and information in the electronic medical record database. For example, a message can be created and sent to an individual, such as a doctor, every time that a patient is admitted to a hospital and that includes the vital signs of the individual. Based on the information in the electronic medical record database and the vital sign data in the message, the priority level of the message can be determined. In one example, a given blood pressure for one person may not be abnormal while the same blood pressure for another person may be abnormal and may thus make the priority level of the message higher.

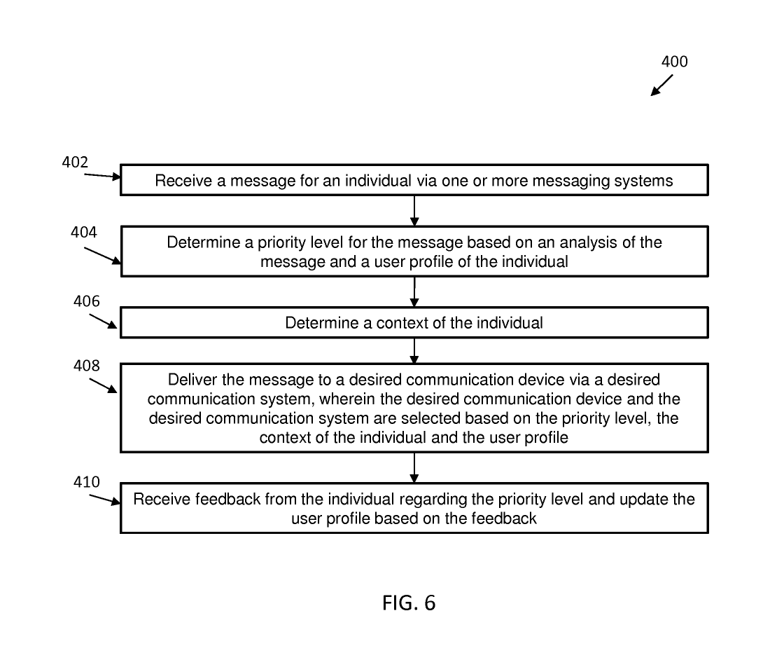

Referring now to FIG. 6, a flow diagram of another method 400 for prioritizing delivery of messages across multiple communication systems in accordance with an exemplary embodiment is shown. As shown at block 402, the method 400 includes receiving a message for an individual via one or more messaging systems. Next, as shown at block 404, the method 400 includes determining a priority level for the message based on an analysis of the message and a user profile of the individual. The method 400 also includes determining a context of the individual, as shown at block 406. The context may include what communication device and communication system the individual is currently utilizing (if any), what communication devices are in their vicinity and where the individual is located. In exemplary embodiments, the context of the individual may be based on the individual's interaction with one or more messaging systems via one or more communication devices and/or based on the input from one or more sensors disposed in the one or more communication devices.

Continuing with reference to FIG. 6, as shown at block 408, the method 400 includes delivering the message to a desired communication device via a desired communication system, wherein the desired communication device and the desired communication system are selected based on the priority level, the context of the individual and the user profile. The method 400 includes receiving feedback from the individual regarding the priority level and updating the user profile based on the feedback, as shown at block 410.

In exemplary embodiments, the feedback form the individual regarding the priority level can include instructions on a change in the priority level that should be assigned to new messages that are similar to the delivered message. For example, the feedback can include a reason that the individual does not want the message to be treated as urgent, such as the sender's messages are never to be treated as urgent, this type of message should not be treated as urgent, or the like. The messaging system can use the feedback provided by the user to update the user profile for the individual.

In exemplary embodiments, the feedback can be created by the individual selecting either an indication of the determined priority level or an indication of why the message was give the indicated priority level and entering feedback to the messaging system regarding the determined priority level why the message was give the indicated priority level. In exemplary embodiments, the feedback can be entered in free form or the feedback may be created by selecting from a list of provided options. In addition, the feedback can include changes to message delivery preferences and/or message priority preferences of the individual. In exemplary embodiments, message delivery preferences include the individual's preferences as to how to deliver messages having different priority levels to the individual and message priority preferences include the individual's preferences as to how to determine the priority level assigned to a message.

In exemplary embodiments, the messaging system is configured to monitor the context of individuals that are using the messaging system. In exemplary embodiments, the context of the individual includes where the individual is in a figurative, online sense at any given time. For example, the messaging system may know that the individual just used their smartphone, or that the individual just sent an email from their personal email account, or that the individual just left a comment on their social networking application, or the like. Accordingly, when an urgent message is received, the messaging system will deliver the message to the place where the individual is, so that the individual can see it right away. If a non-urgent message is received, the messaging system may be configured to deliver the message in a less urgent fashion, e.g., using a medium that the individual typically uses for non-urgent messages.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method for prioritizing delivery of messages across multiple communication systems, the computer implemented method comprises:
receiving a message for a recipient via one or more messaging systems;
determining a priority level for the message based on an analysis of the message and a user profile of the recipient;
delivering the message to a desired communication device via a desired communication system, wherein the desired communication device and the desired communication system are selected based on the priority level and the user profile; and
receiving feedback from the recipient regarding the priority level and responsively updating the user profile based on the feedback.

2. The computer implemented method of claim 1, further comprising determining a context of the recipient based on an interaction of the recipient with one or more communication devices.

3. The computer implemented method of claim 2, wherein selection of the desired communication device and the desired communication system are further based on the context of the recipient.

4. The computer implemented method of claim 1, wherein the analysis of the message includes analyzing one or more of a content of the message, a sender of the message, a distribution list of the message.

5. The computer implemented method of claim 1, wherein the feedback includes instructions on a change in the priority level that should be assigned to new messages.

6. The computer implemented method of claim 1, wherein the priority level is further determined based on information obtained from an information system that relates to the message.

7. The computer implemented method of claim 6, wherein the information system is an electronic medical record database and wherein determining the priority level of the message is based on an analysis of a combination of information in the message and information in the electronic medical record database.

8. A computer program product for prioritizing delivery of messages across multiple communication systems, the computer program product comprising:
a non-transitory storage medium readable by a processing circuit and storing instructions for execution by the processing circuit for performing a method comprising:
receiving a message for an recipient via one or more messaging systems;
determining a priority level for the message based on an analysis of the message and a user profile of the recipient;
delivering the message to a desired communication device via a desired communication system, wherein the desired communication device and the desired communication system are selected based on the priority level and the user profile; and
receiving feedback from the recipient regarding the priority level and responsively updating the user profile based on the feedback.

9. The computer program product of claim 8, wherein the method further comprises determining a context of the recipient based on an interaction of the recipient with one or more communication devices.

10. The computer program product of claim 9, wherein selection of the desired communication device and the desired communication system are further based on the context of the recipient.

11. The computer program product of claim 8, wherein the analysis of the message includes analyzing one or more of a content of the message, a sender of the message, a distribution list of the message.

12. The computer program product of claim 8, wherein the feedback includes instructions on a change in the priority level that should be assigned to new messages.

13. The computer program product of claim 8, wherein the priority level is further determined based on information obtained from an information system that relates to the message.

14. The computer program product of claim 13, wherein the information system is an electronic medical record database and wherein determining the priority level of the message is based on an analysis of a combination of information in the message and information in the electronic medical record database.

15. A messaging system for prioritizing delivery of messages across multiple communication systems, comprising:
a processor in communication with one or more types of memory, the processor configured to:
receive a message for a recipient via one or more messaging systems;
determine a priority level for the message based on an analysis of the message and a user profile of the recipient;
deliver the message to a desired communication device via a desired communication system, wherein the desired communication device and the desired communication system are selected based on the priority level and the user profile; and
receive feedback from the recipient regarding the priority level and responsively updating the user profile based on the feedback.

16. The messaging system of claim 15, wherein the processor is further configured to determine a context of the recipient based on an interaction of the recipient with one or more communication devices.

17. The messaging system of claim 15, wherein the analysis of the message includes analyzing one or more of a content of the message, a sender of the message, a distribution list of the message.

18. The messaging system of claim 15, wherein the feedback includes instructions on a change in the priority level that should be assigned to new messages.

19. The messaging system of claim 15, wherein the priority level is further determined based on information obtained from an information system that relates to the message.

20. The messaging system of claim 19, wherein the information system is an electronic medical record database and wherein determining the priority level of the message is based on an analysis of a combination of information in the message and information in the electronic medical record database.
